(19) United States
(12) Patent Application Publication
(10) Pub. No.: US 2019/0210899 A1
(43) Pub. Date: Jul. 11, 2019

(54) Water Treatment System And Method

(71) Applicant: Sydney Water Corporation, Parramatta (AU)

(72) Inventors: Kimson Lam, Potts Hill (AU); Anthony John Sinton, Parramatta (AU); Barry John Cook, Potts Hill (AU); Jeffrey David Scott, Potts Hill (AU); Leighton William Cramp, Parramatta (AU); Darren Azzopardi, Potts Hill (AU)

(21) Appl. No.: 16/358,156

(22) Filed: Mar. 19, 2019

Related U.S. Application Data
(63) Continuation-in-part of application No. PCT/AU2017/051015, filed on Sep. 18, 2017.

(30) Foreign Application Priority Data
Sep. 19, 2016 (AU) 2016903766

(51) Int. Cl. C02F 1/68; C02F 1/00

(52) U.S. Cl. CPC C02F 1/686; C02F 1/008; C02F 2209/42; C02F 2201/008; C02F 2201/005; C02F 2209/008; C02F 2209/29; C02F 2301/046

(57) ABSTRACT

A compact transportable water treatment system for treating water in a reservoir includes a batching unit having a chemical hopper for holding dissolvable chemicals and having a fluid inlet for delivery of fluid into the hopper for dissolving the chemicals to create a chemical solution and a fluid outlet in a lower portion of the chemical hopper for outflow of chemical solution. The batching unit further includes a fluid delivery system configured to deliver the fluid to the chemical hopper through the fluid inlet and a batching tank that receives and holds the chemical solution passing from the fluid outlet. A dosing unit comprising at least one dosing pump is configured to pump the chemical solution from the batching tank to a dosing line. A control unit controls operation of the dosing unit responsive to a chemical concentration of the water in the reservoir.

### CROSS-REFERENCE TO RELATED APPLICATIONS

The present application claims priority from Australian Provisional Patent Application No 2016903766 filed on 19 Sep. 2016 and is related to International Application No. PCT/AU2015/051015 filed on 18 Sep. 2017, the contents of both being incorporated herein by reference.

### TECHNICAL FIELD

The present disclosure relates, generally, to a water treatment system and a method of treating water in a water reservoir. In one form the disclosure relates to a compact transportable water treatment system.

### BACKGROUND

To maintain the required secondary disinfectant residual in a water supply network, the disinfectant, for example chlorine, is continuously monitored, and disinfectant is added to the water supply when there is a reduction in the chlorine residual. One way of adding chlorine is to fill canisters with chlorine tablets, and then drop the canisters into a water reservoir. When the chlorine levels are reduced, operators retrieve the canisters (typically through roof hatches of the water reservoir), refill the canisters with chlorine tablets, and return the canisters through the roof into the reservoir. This method relies heavily on manual labour, and manual labour under dangerous circumstances on a reservoir roof. In addition, the cost of roof construction reflects both the constraints of a reservoir roof that must be safe enough to bear the weight of an operator replacing canisters, and the cost of access structures such as stairways. The manual reloading of chlorine tablets also results in significant corrosion of reservoir roofs.

An alternative approach is to install a chlorine dosing plant next to a water reservoir. A dosing plant typically includes a chemical loading bay, bulk storage tanks for chemicals in various forms, and permanent pipelines that recirculate reservoir water via the dosing plant chemical solution tanks. Because of the required infrastructure, these plants are typically relative large and require at least 10 m×10 m of ground space next to a reservoir. As a consequence of the required infrastructure dosing plants are also very costly.

Another approach is erosion dosing. Erosion dosing uses chlorine tablets in a hopper through which water flows to dissolve the tablets. The resulting chlorine solution is stored in a tank before being added to the water reservoir. However, maintaining sufficient chlorine residual in a large reservoir is difficult due to the limited and variable dissolution rate. In addition, the chlorine concentration in the solution is extremely variable.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect of the disclosure, there is provided a compact transportable water treatment system for treating water in a reservoir, the water treatment system comprising:
a batching unit comprising:
   a chemical hopper for holding dissolvable chemicals, the chemical hopper comprising:
      a fluid inlet for delivery of fluid into the hopper for dissolving the chemicals to create a chemical solution; and
      a fluid outlet in a lower portion of the chemical hopper for outflow of chemical solution;
   a fluid delivery system configured to deliver the fluid to the chemical hopper through the fluid inlet; and
   a batching tank that receives and holds the chemical solution passing from the fluid outlet;
a dosing unit comprising at least one dosing pump configured to pump the chemical solution from the batching tank to a dosing line; and
a control unit that controls operation of the dosing unit responsive to a chemical concentration of the water in the reservoir.

In another aspect of the disclosure, there is provided a compact transportable water treatment system comprising:
a batching unit comprising:
   a chemical hopper, a lower portion of which comprises a porous grid;
   a spray system configured to spray fluid from a fluid ingress through the porous grid to dissolve chemicals in the chemical hopper, thereby creating a chemical solution that flows through the porous grid; and
   a batching tank that receives and holds the chemical solution;
   a recirculation pump and recirculation line that are configured to recirculate the chemical solution in the batching tank;
   a level sensing system configured to monitor a plurality of level parameters associated with at least one of the chemical hopper and the batching tank;
   a dosing unit comprising at least one dosing pump configured to pump the chemical solution from the batching tank to a dosing line; and
   a control unit that controls operation of the batching unit, the recirculation pump, and the dosing unit responsive to the level sensing system.

The control unit may selectively interlock operation of the water spray system, the recirculation pump, and/or the dosing unit responsive to the level sensing system.

As used herein, “interlock” refers to reversibly stopping or pausing operation of a mechanism under specified conditions.

The level sensing system may comprise at least one sensor for sensing a level of the chemical solution in the batching tank. The at least one level sensor may comprise at least one capacitive level sensor external to the batching tank. The at least one sensor may be positioned to not be in contact with the chemical solution. The at least one sensor may comprise a triple-level sensor, the triple-level sensor comprising a low level sensor, a high level sensor and an operation level sensor.

The level sensing system may comprise a hopper chemical level sensor for determining a level of chemical in the hopper. The hopper chemical level sensor may comprise a weight sensing system that bears the load of the chemical hopper. The weight sensing system may further bear the load of the batching tank. The hopper chemical level sensor may comprise a distance sensor configured to measure a height of chemical in the hopper. The hopper chemical level sensor may provide hopper chemical level data to the control unit, and the control unit may be configured to derive a level of chemical in the hopper from the hopper chemical level data.

As used herein, unless the context clearly indicates otherwise, the term “level” is to be understood to mean an amount, height, volume, weight or the like.

The level sensing system may comprise an auxiliary level sensor for deriving a level parameter associated with the batching tank.

The dosing unit may further comprise a dosing valve for selectively allowing and disallowing fluid communication between the batching tank and the dosing line. The dosing unit may comprise a flow sensor. The flow sensor may be a dosing valve flow switch. The control unit may control the dosing pump responsive to a dosing pump speed. The control unit may control the dosing pump responsive to the flow sensor.

The water treatment system may further comprise a carrier water delivery system for delivering the chemical solution, wherein the carrier water delivery system receives the chemical solution from the dosing line.

The water treatment system may comprise a housing for containing the batching unit, the recirculation pump and recirculation line, the level sensing system, the dosing unit, and the control unit. The housing may comprise a chemical bund and a bund level sensor. The control unit may interlock operation of the spray system, the recirculation pump and the at least one dosing pump in response to the bund level sensor sensing that a liquid level in the bund has reached or exceeded a predetermined value. The dosing line may comprise a primary conduit and a secondary conduit sleeved thereover, such that leaks from the primary conduit are contained by the secondary conduit and returned to the chemical bund.

The water treatment system may further comprise a booster pump configured to pump water from an external source to the spray system, and wherein the control unit controls operation of the booster pump responsive to the level sensing system. In some embodiments a booster pump may be used to pump water from a clean water source to an operator safety water supply, e.g. to an eyewash. In some embodiments two booster pumps are used, and in other embodiments the same booster pump is used for both applications. In one embodiment, the same booster pump may also be configured to pump water from the external source to the operator safety water supply. The one or more booster pumps may maintain a system water pressure independent of an external supply water pressure.

The water treatment system may comprise an access sensor, and the control unit may operate the booster pump to pump water to the operator safety water supply if the access sensor indicates that the housing has been accessed.

The water treatment system may comprise a communication unit in communication with a remote location thereby enabling remote monitoring and control of the system.

In another aspect of the disclosure, there is provided a method of treating water in a water reservoir, the method comprising:
operating a batching unit to prepare a chemical solution from a supply of chemical;
storing the chemical solution in a batching tank;
operating a recirculation pump to recirculate the chemical solution in the batching tank;
operating a dosing unit having at least one dosing pump to add a dose of the chemical solution from the batching tank to the reservoir;
monitoring a plurality of level parameters associated with at least one of the supply of chemical and the batching tank; and
selectively interlocking operation of the batching unit, the recirculation pump, and/or the dosing unit in response to the plurality of level parameters.

Monitoring the plurality of level parameters may comprise deriving a level parameter associated with the batching tank by measuring the weight of the batching tank.

Selectively interlocking operation of the batching unit, the recirculation pump, and/or the dosing unit may be in response to a measured parameter indicative of a bund fluid level exceeding a predetermined value, a local manual shutdown command, and/or a remote manual shutdown command.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 is a schematic representation of an embodiment of a water treatment system;

FIG. 2 is a flow diagram of an embodiment of a method of treating water in a reservoir;

FIG. 3 is a flow diagram of an embodiment of a method of treating water in a reservoir;

FIG. 4 shows a graph of chlorine concentration over time;

FIG. 5 is a schematic representation of a water treatment system that includes an embodiment of a carrier water delivery system; and

FIG. 6 is a schematic representation of a water treatment system that includes another embodiment of a carrier water delivery system.

### DESCRIPTION OF EMBODIMENTS

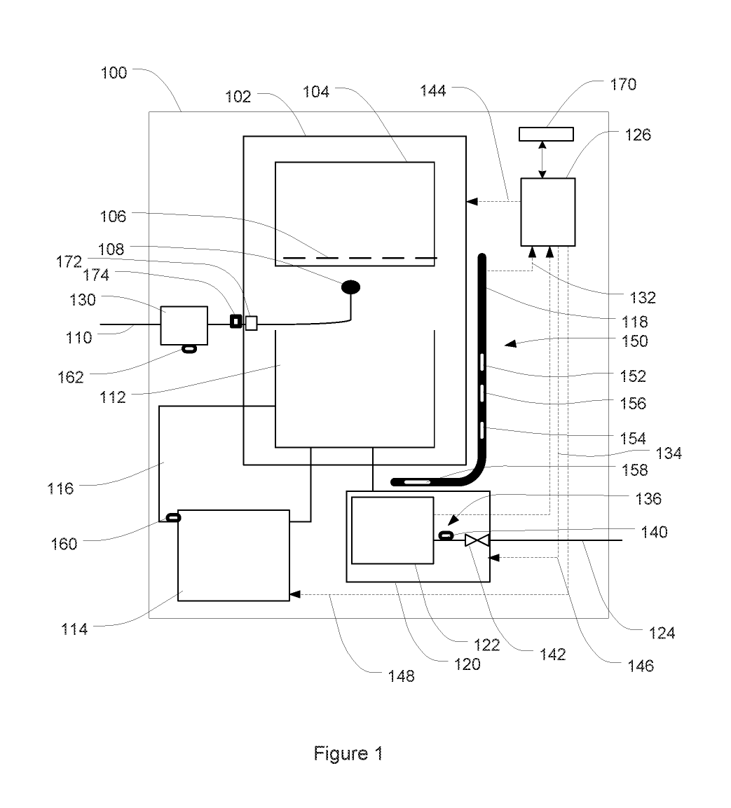

Referring to FIG. 1 of the drawings, a compact transportable water treatment system 100 has a batching unit 102 that includes a chemical hopper 104 with a lower portion that has a porous grid 106. The batching unit 102 has a spray system 108 configured to spray fluid from a fluid ingress 110 through the porous grid 106 to dissolve chemicals in the chemical hopper 104. This creates a chemical solution that flows through the porous grid 106. The batching unit 102 has a batching tank 112 that receives and holds the chemical solution, and a recirculation pump 114 and recirculation line 116 are used to recirculate the chemical solution in the batching tank 112. The system 100 has a level sensing system 118 that monitors various level parameters associated with the chemical hopper 104 and/or the batching tank 112, for example a minimum and/or maximum solution level in the batching tank 112. A dosing unit 120 with at least one dosing pump 122 (such as a peristaltic pump) pumps the chemical solution from the batching tank 112 to a dosing line 124 to treat water, for example in a reservoir. In some embodiments more than one dosing pump may be provided, for example to ensure system redundancy and/or to increase dosing capacity. Operation of the system 100 is controlled by a control unit 126. The control unit 126 controls operation of the batching unit 102, the recirculation pump 114, and the dosing unit 120 responsive to the various level parameters as described in more detail below.

The control unit 126 may interlock the batching unit 102, the recirculation pump 114, and/or the dosing unit 120 responsive to the various fluid parameters if the parameters fall outside of normal or safe operation ranges.

The system 100 is transportable because of its relatively small size. This small size is facilitated by the system being configured for continuous relatively small volume disinfectant dosing of a water supply, such as a reservoir, to maintain disinfectant concentration in the water supply within a relatively small range. As such, the batching unit 102 and dosing unit 120 are relatively small, since they only need to make, hold and deliver relatively small volumes of the chemical solution. Small volume batching and dosing by the system 100 also has the advantage of ensuring that the chemical solution in the batching tank 112, and therefore the chemical solution delivered to the water supply/reservoir, is kept fresh, as the relatively small volume of chemical solution held in the batching tank 112 is continuously being drawn upon by the dosing unit 120 and refreshed by the addition of freshly made chemical solution. Ideally, the chemical solution is made on an “on demand” and “just in time” basis. The modularity of the system 100, which consists of separate batching unit 102 and dosing unit 120 modules, also facilitates transportability. The Constant Chlor® Plus MC4-50 Calcium Hypochlorite Feeding System is an example of a system that can be relatively easily modified for use as batching unit 102. The components of the system 100 are designed to fit into a housing that has an integral chemical bund, and a relatively small footprint. The housing containing the system 100 is transportable as a whole to the water source (e.g. reservoir) where it is deployed.

The control unit 126 controls operation of the system 100. The control unit 126 has a processor, typically a programmable logic controller (PLC) or other type of automatic control system known to those in the art having the benefit of this disclosure. The control unit 126 also includes memory containing instructions to be executed by the PLC, and an I/O interface for communicating with components of the system 100. The control unit 126 receives input data from various components in the system 100 as well as a number of sensors that monitor parameters in and around the system 100. Based on operational set points together with the received input data, the control unit 126 controls both normal operation of the system 100, and also responds to input data indicative of abnormal, unusual or dangerous states of the system 100, for example by interlocking one or more components within the system 100.

Table 1 provides a summary of the operations that may be interlocked, terminated or paused based on input data received from various sensors.

TABLE 1
Sensor measurements associated with interlocking batching,
recirculation or dosing

| Sensors | Batching | Recirculation | Dosing |
|---|---|---|---|
| 1. Low level sensor 154 | | x | x |
| 2. High level sensor 152 | x | | |
| 3. Operation level sensor | x | | |
| 156 | | | |
| 4. Derived level sensor 158 | | x | x |
| 5. Recirculation pressure | x | x | |
| sensor 160 | | | |
| 6. Booster pump pressure | x | | |
| sensor 162 | | | |
| 7. Dissolution water | x | | |
| pressure sensor 174 | | | |
| 8. Dosing valve flow switch | | | x |
| 140 | | | |
| 9. Secondary containment | | | x |
| level sensor | | | |
| 10. Bund level sensor | x | x | x |
| 11. Tank lid sensor | x | x | |
| 12. Chlorine range | | | x |
| 13. Reservoir mixer | | | x |

In some embodiments, the control unit 126 receives level sensing data 132 from the level sensing system 118. Responsive to the input data (that may include both level sensing data 132 and dosing unit data 134, described elsewhere herein with reference to the dosing unit 120) the control unit 126 provides batching unit control parameters 144, dosing unit control parameters 146, and recirculation parameters 148.

The level sensing system 118 has at least one level sensor that senses the fluid level of the solution in the batching tank 112. In some embodiments the level sensors are capacitive sensors mounted on the outside of the batching tank 112 at a height above the base of the tank 112 that coincides with a volume threshold or volume range to be monitored. An example of a suitable capacitive sensor is the KQ6003 sensor from ifm efector, inc.

In some embodiments the level sensing system 118 includes a triple-level sensor 150 that consists of three level sensors: a high level sensor 152, a low level sensor 154 and an operation level sensor 156 therebetween. The high level sensor 152 is positioned to monitor a maximum batching tank capacity level above which the tank may overflow. The low level sensor 154 is positioned to monitor a minimum batching tank capacity below which the contents of the tank cannot be effectively recirculated or provide the required chemical dose during dosing. The operation level sensor 156 is positioned to monitor an optimal or normal batching tank volume range, Vₜₕ₂−Vₜₕ₁=ΔV. Batching is enabled (by turning on a booster pump 130 and spray system 108 that includes a spray nozzle) when the volume is below a first volume threshold, Vₜₕ₁, and batching is disabled once a second volume threshold, Vₜₕ₂, is reached.

When the system 100 is installed at a reservoir, the fluid ingress 110 from the reservoir is typically at a relatively low water pressure. The booster pump 130 is used to pump water from the reservoir to the system 100, and specifically to the spray system 108.

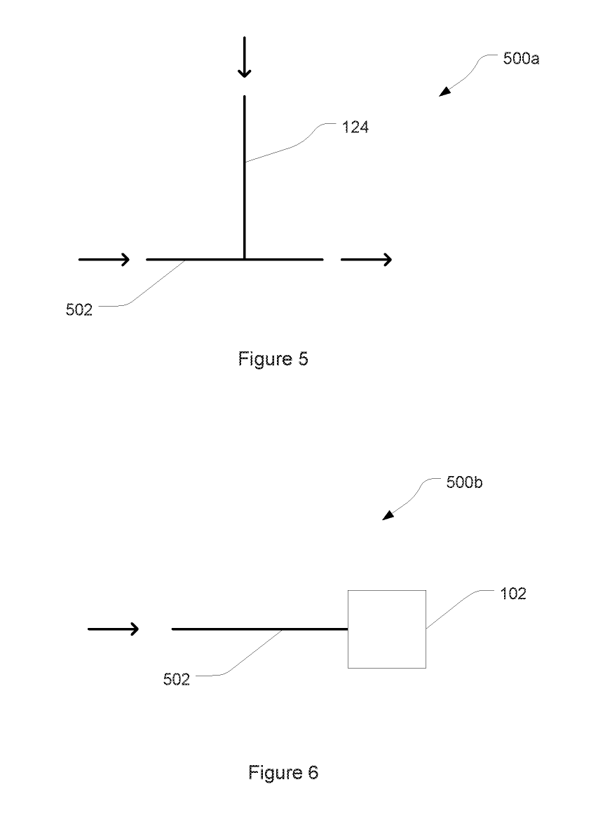

Referring to FIG. 5 of the drawings, in some embodiments, the system 100 includes a carrier water delivery system 500a that provides carrier water via a carrier water supply line 502 to facilitate the rapid delivery of the chemical solution from dosing line 124 to the dosing point in the reservoir and to provide assistance in the mixing of the chemical into the water to be treated. The open headed arrows in FIG. 5 indicate the direction of fluid flow. In some embodiments, in addition to pumping water from fluid ingress 110 to the spray system 108, the booster pump 130 may also form part of the carrier water delivery system 500a and may pump water from fluid ingress 110 to carrier water supply line 502. Additionally or alternatively a dedicated carrier water pump may be used to pump carrier water from the reservoir, via fluid ingress 110 or otherwise, to the carrier water supply line 502. The dosing line 124 provides the chemical solution to the carrier water supply line 502, in which the chemical solution combines with the carrier water. The carrier water supply line 502 delivers the combined carrier water and chemical solution to the dosing point in the reservoir. The chemical concentration in the batching tank 112 is typically relatively high, for example between 50 and 80% available chlorine, typically between 60 and 70% available chlorine. The carrier water supplied to the carrier water supply line 502 is provided from the reservoir, so has a significantly lower chemical concentration as it arrives at the system 100. As a result of combining with the carrier water in carrier water supply line 502, the concentration of the chemical solution is lowered to between 1 and 2%, for example at around 1.2%. This lower concentration chemical solution is delivered to the reservoir, where the chemical concentration is typically maintained at around 1.3 mg/l.

FIG. 6 illustrates an alternative embodiment of a carrier water delivery system 500b for use in system 100. The open headed arrow in FIG. 6 indicates the direction of fluid flow. System 500b operates similarly to system 500a, but, rather than carrier water being combined with chemical solution from the batching unit 102 downstream of the dosing pump 122, the carrier water supply line 502 of system 500b delivers carrier water to the batching unit 102 (for example directly into the tank 112, or via the outlet from the batching unit 102 into the dosing unit 120) to dilute the chemical solution received by the dosing unit 120 from the batching unit 102. System 500b may be used to reduce or avoid clogging of components of system 100, such as the dosing pump 122 or dosing line 124, by diluting the concentration of the chemical solution produced in the batching unit 102.

The housing typically includes an operator safety water supply, for example for a safety eyewash or safety shower, and the booster pump 130 is also used to pump water to the operator safety water supply. In some embodiments separate booster pumps are used for each purpose individually, and in other embodiments the same booster pump is used for all applications. In some embodiments the housing includes an access sensor, and when the access sensor senses that the housing has been accessed by an operator, the booster pump 130 is turned on as a safety precaution in the event that the operator requires the eyewash. In addition, the batching tank 112 has a tank lid sensor that senses access to the tank 112, and if the tank lid sensor is activated the control unit 126 will pause operation of the batching unit 102 as well as the recirculation pump 114 to ensure the safety of the operator.

In summary, the booster pump 130 is typically operated: (1) for batching when the dissolution sequence is running, (2) for dosing when the dosing pumps are running, and (3) when the housing door is open and the access sensor activated. The booster pump 130 advantageously renders the system 100 substantially independent of an external supply water pressure because the booster pump 130 is able to maintain the required water pressure within the system 100 irrespective of typical fluctuations that can be expected in the water supply, e.g. provided from a reservoir.

In some embodiments the level sensing system 118 includes at least one weight transducer 158 (for example one or more load cells) that is used to track the changing weight of the batching unit 102, which includes the cyclical change of fluid entering and leaving the batching tank 112, as well as the progressive decrease in the chemical held in the chemical hopper 104. The weight transducer 158 acts as a hopper chemical level sensor when the weight data is used by the control unit 126 to determine if a lower threshold of chemical has been reached in order to alert an operator to replenish the chemical hopper 104. In some embodiments, the weight transducer 158 acts as an auxiliary weight sensor when the weight data provided is used by the control unit 126 to derive an approximate fluid level in the batching tank 112 as a backup to the triple-level sensor. The fluid level is derived from the measured weight based on the filling status as tracked by the cumulative weight trend.

In some embodiments the hopper chemical level sensor may additionally or alternatively include a distance measuring sensor used to sense the height of chemical levels within the hopper, and the volume of the chemical in the hopper can then be derived from the measured height. Examples of sensors that may be used for the distance sensor are ultrasonic and laser based sensors. By using a distance sensor in addition to the weight sensor, the auxiliary level sensor derived parameter(s) may be determined from the physical level of the chemical in the hopper and the weight of the batching unit 102.

In some embodiments the recirculation pump 114 is associated with a recirculation pressure sensor 160 that monitors the pressure before, within, and/or after the recirculation pump 114 and provides recirculation pressure data to the control unit 126. If the recirculation pressure is outside of a normal operating range the control unit 126 is configured to stop or pause operation of the recirculation pump 114.

In some embodiments the booster pump 130 is associated with a booster pump pressure sensor 162 that monitors water pressure provided by the booster pump 130 to the system 100. The control unit 126 is configured to pause operation or alter the set points of the booster pump 162 in the event that the booster pump pressure is outside a normal operation range. A valve 172 (for example a solenoid valve) is used to control the spray system 108 and in effect the batching process. A dissolution water pressure sensor 174 is used to measure the water pressure provided to the valve 172 so that the system 100 is able to maintain a consistent water pressure for the operation of the dissolution process in the batching unit 102. In some embodiments, the system includes a pressure reducing valve operated in response to the pressure measured by the dissolution water pressure sensor 174,

The dosing unit 120 includes a dosing valve 142. In some embodiments, the control unit 126 receives dosing unit data 134 from a dosing unit sensing system 136. The dosing unit sensing system 136 includes a sensor for sensing flow to the valve 142, such as a dosing valve flow switch 140. An example of a dosing valve is a Georg Fischer Type 107 24 VDC electrically actuated uPVC ball valve with position feedback limit switches. This valve is configured such that in the event of a power failure to the system, a battery backed power supply will ensure the valve drives closed to prevent syphoning upon loss of power to the system. The pump flow rate is derived from the pump speed set point data that is provided by the dosing pump 122 to the control unit 126, while the flow switch 140 confirms the flow of chemical solution.

Dosing is also monitored by a secondary containment level sensor (not shown) associated with secondary containment of the dosing line 124. The secondary containment level sensor is positioned on a secondary pipeline that encases the dosing line 124. The secondary pipeline leads any overflow or leaks from the dosing line 124 back towards the housing of the system 100, and returns any overflow or leaks from the dosing line 124 to the chemical bund in the housing. In some embodiments an alternative capture point may be provided in addition to, or as an alternative to, the chemical bund. An increased fluid level in the secondary pipeline (as measured by the secondary containment level sensor) may be indicative of a serious leak from the dosing line 124. The measurement data provided by the secondary containment level sensor is provided to the control unit 126 which will turn off the dosing pump 122 if a secondary containment threshold level is sensed. Similarly, the housing includes a bund level sensor, and if a threshold bund level is sensed the control unit 126 will interlock operation of the batching unit 102, the recirculation pump 114 as well as the dosing pump 122.

Additionally, in controlling operation of the dosing unit 120, the control unit 126 responds to input data received from a chemical analyser regarding the chemical concentration in the reservoir water that is to fall within a predetermined range, as well as input data relating to the normal operation of the reservoir mixer positioned inside the reservoir. In some embodiments the chemical analysis may be done with a chemical analyser that forms part of the system 100. In other embodiments, the data relating to the chemical analysis as well as the reservoir mixer are received by the control unit 126 via a communications unit 170. The communications unit 170 may provide any suitable wired or wireless electronic interface. In addition to receiving data from the chemical analyser and about the reservoir mixer, the communications unit 170 also provides a communication link between the system 100 and a remote location so that the system can be monitored and controlled remotely. An example communications unit 170 includes a programmable logic controller (PLC) in communication with a site remote telemetry unit (RTU) via RS485 serial link using Modbus RTU open protocol.

Remote control of the system 100 may include the provision of operational set points to the control unit 126. Remote control may also include interlocking, pausing, resetting, adjusting or shutting down one or more of the components of the system, e.g. the batching unit 102, the dosing unit 120, and/or the recirculation pump 114. In addition to the remote capability of shutting down any or all of the system components, a local shutdown safety switch is also provided that will shut down operation of at least the batching unit 102, the dosing unit 120 and the recirculation pump 114. The remote and local system shutdown is a full system shutdown that also switches off all valves. As part of, or in addition to, the local shutdown safety switch, the system 100 may also include a tank service switch for when the tablets need to be refilled or maintenance work is to be undertaken in the cabinet that requires the dosing or batching shut down. The tank service switch will not switch off the booster pump 130 as the eyewash must be operational when the system 100 is accessed by an operator.

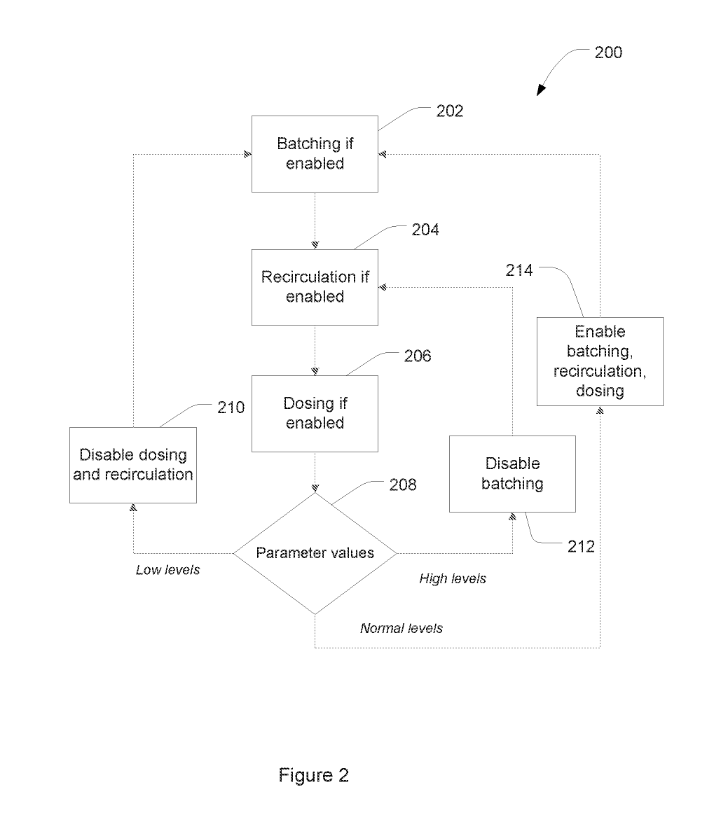

FIG. 2 of the drawings shows a flow diagram that illustrates a method 200 of treating water in a water reservoir. The basic water treatment process starts with batching 202 during which a chemical solution is prepared from a supply of chemical briquettes or tablets held in the chemical hopper 104. The chemical solution is stored in the batching tank 112, and recirculation 204 of the chemical solution in the batching tank 112 ensures that any undissolved particles of the chemicals are maintained in a suspension. Depending on the requirements for the water being treated (based on the concentration of the chemicals in the water in the reservoir), dosing 206 adds the required dose of chemical solution to the water in the reservoir.

In some embodiments the dosing volume per dose is predetermined and constant, for example the dosing volume may be equal to the operating volume of solution maintained in the batching tank 112. In other embodiments the dosing volume per dose may increase or decrease depending on the reservoir's chemical concentration, and the changeable dosing volume is provided by the dosing pump 122 under the control of the control unit 126. Various parameters in and around the system 100 are monitored and the monitored parameters affect how the system 100 is operated. As shown in FIG. 2, at 208, various parameters are considered by the control unit 126. Referring specifically to the fluid level in the batching unit 112 as described above, a fluid level below the low volume threshold, V_{L}, will result in the control unit 126 disabling dosing and recirculation 210. If the batching fluid level is above a high volume threshold, V_{H}, the system will shut down at 212. If the fluid levels are within the normal range, ΔV, batching, recirculation, and dosing are enabled 214 and will proceed as usual.

In summary, for the measured volume V:
When V_{L}<V<Vₜₕ₂, batching occurs and dosing is enabled;
When V=Vₜₕ₂, batching stops but dosing is enabled;
When V<V_{L} OR V>V_{H}, shut down conditions are enabled.

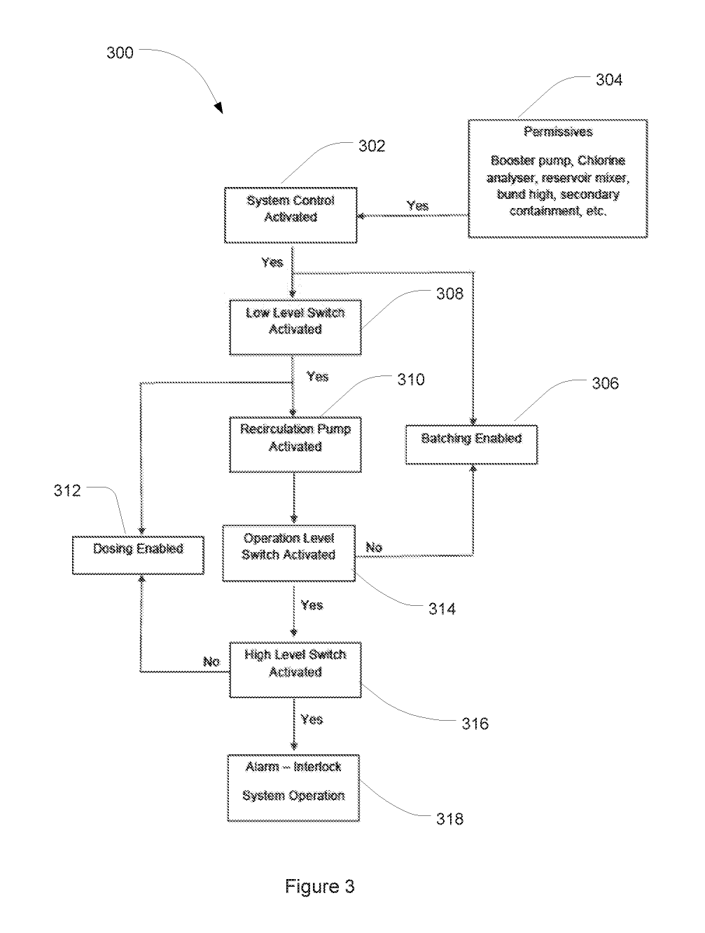

FIG. 3 of the drawings shows a flow diagram that illustrates a method 300 of operating a water treatment system. At 302 the system control is activated depending on one or more permissives 304 that include, but are not limited to, parameters relating to the operation of the booster pump 130, measured chlorine levels, operation of the reservoir mixer, the measured bund level, and the measured secondary containment level. At 306 batching is enabled. If the low level switch is activated at 308 then the recirculation pump is activated at 310 as well as dosing at 312. Batching remains enabled until the operation level switch is activated at 314. If the high level switch is activated at 316 then system interlocks are activated at 318.

Advantageously, the water treatment system described herein has a small footprint (from around 1 m×2 m), and can therefore be provided as a transportable unit. This also makes for a cost-effective water treatment solution with very little infrastructure required in comparison to a full-scale water treatment plant for example. Using chemical briquettes or tablets means that access to large delivery trucks typically does not have to be provided. Implementation in a relatively small housing where an operator will stand outside of the housing reduces infrastructure requirements associated with occupational health and safety, such as the provision of ventilation.

Using a carrier water delivery system 500a enhances mixing of the chemical solution output from system 100 into the reservoir by increasing the volume and speed of water movement in the reservoir.

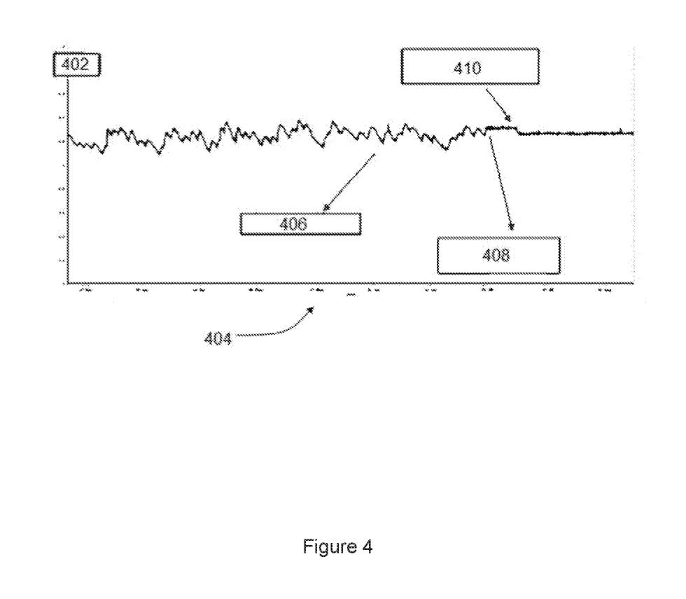

Advantageously, the use of a batching unit results in the accurate control of chemical concentrations in the batching tank and subsequently in the dosed fluid. This is in contrast to, for example, erosion dosing where the chemical concentration in the solution is highly variable, as can be seen in FIG. 4. The graph shows the chlorine concentration 402 on the y-axis and elapsed time 404 on the x-axis. This chlorine concentration is in the reservoir. The first portion 406 of the data shows the variable chlorine concentration when erosion dosing is used. The method of chemical dosing changes to the method described herein at 408. The chlorine concentration is significantly more stable in the second portion 410 of the data In addition, the chemical solution delivered to the water supply/reservoir, is kept fresh by using smaller batch sizes than the typical batch sizes associated with erosion dosing where the available disinfectant decays on storage.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A compact transportable water treatment system for treating water in a reservoir, the water treatment system comprising:
a batching unit comprising:
a chemical hopper for holding dissolvable chemicals, the chemical hopper comprising:
a fluid inlet for delivery of fluid into the hopper for dissolving the chemicals to create a chemical solution; and
a fluid outlet in a lower portion of the chemical hopper for outflow of the chemical solution;
a fluid delivery system configured to deliver the fluid to the chemical hopper through the fluid inlet; and
a batching tank that receives and holds the chemical solution passing from the fluid outlet;
a dosing unit comprising at least one dosing pump configured to pump the chemical solution from the batching tank to a dosing line; and
a control unit that controls operation of the dosing unit responsive to a chemical concentration of the water in the reservoir.

2. The water treatment system of claim 1, further comprising a chemical analyser that determines the chemical concentration of the water in the reservoir and provides data regarding the chemical concentration to the control unit.

3. The water treatment system of claim 1, wherein the dosing unit adds a predetermined dosing volume per dose to the reservoir at varying time intervals as determined by the control unit.

4. The water treatment system of claim 1, wherein the dosing unit adds a changeable dosing volume per dose to the reservoir as determined by the control unit.

5. The water treatment system of claim 1, wherein the control unit controls operation of the dosing unit to maintain the chemical concentration of the water in the reservoir within a predetermined range.

6. The water treatment system of claim 1, wherein the fluid inlet and the fluid outlet comprise a porous grid in a lower portion of the chemical hopper.

7. The water treatment system of claim 1, wherein the fluid delivery system comprises a spray system configured to spray fluid through the fluid inlet.

8. The water treatment system of claim 1, further comprising a recirculation pump and recirculation line that are configured to recirculate the chemical solution in the batching tank.

9. The water treatment system of claim 8, further comprising a level sensing system configured to monitor a plurality of level parameters associated with at least one of the chemical hopper and the batching tank, and wherein the control unit selectively interlocks operation of the water spray system, the recirculation pump, and/or the dosing unit responsive to the level sensing system.

10. The water treatment system of claim 9, wherein the level sensing system comprises at least one sensor for sensing a level of the chemical solution in the batching tank.

11. The water treatment system of claim 10, wherein the at least one level sensor comprises at least one capacitive level sensor external to the batching tank, and wherein the at least one sensor is not in contact with the chemical solution.

12. The water treatment system of claim 10, wherein the at least one sensor comprises a triple-level sensor, the triple-level sensor comprising a low level sensor, a high level sensor and an operation level sensor.

13. The water treatment system of claim 9, wherein the level sensing system comprises a hopper chemical level sensor for determining a level of chemical in the hopper.

14. The water treatment system of claim 13, wherein the hopper chemical level sensor comprises a weight sensing system that bears a load of the chemical hopper.

15. The water treatment system of claim 14, wherein the weight sensing system further bears the load of the batching tank.

16. The water treatment system of claim 13, wherein the hopper chemical level sensor comprises a distance sensor configured to measure a height of chemicals in the hopper.

17. The water treatment system of claim 13, wherein the hopper chemical level sensor provides hopper chemical level data to the control unit, and the control unit is configured to derive a level of chemical in the hopper from the hopper chemical level data.

18. The water treatment system of claim 9, wherein the level sensing system comprises an auxiliary level sensor for deriving a level parameter associated with the batching tank.

19. The water treatment system of claim 1, wherein the dosing unit further comprises a dosing valve for selectively allowing and disallowing fluid communication between the batching tank and the dosing line.

20. The water treatment system of claim 1 further comprising a carrier water delivery system for diluting the chemical solution, wherein the carrier water delivery system includes a pump and provides carrier water via the pump, the carrier water diluting the chemical solution.

21. The water treatment system of claim 1, comprising a housing for containing the batching unit, the recirculation pump and recirculation line, the level sensing system, the dosing unit, and the control unit.

22. The water treatment system of claim 21, wherein the housing comprises a chemical bund and a bund level sensor, wherein the control unit interlocks operation of the spray system, the recirculation pump and the at least one dosing pump in response to the bund level sensor sensing that a liquid level in the bund has reached or exceeded a predetermined value.

23. The water treatment system of claim 22, wherein the dosing line comprises a primary conduit and a secondary conduit sleeved thereover, such that leaks from the primary conduit are contained by the secondary conduit and returned to the chemical bund.

24. The water treatment system of claim 1, further comprising a booster pump configured to pump water from an external source to the spray system, and wherein the control unit controls operation of the booster pump responsive to the level sensing system.

25. The water treatment system of claim 24 wherein the booster pump is further configured to pump water to an operator safety water supply.

26. The water treatment system of claim 25, wherein the system comprises an access sensor, and wherein the control unit operates the booster pump to pump water to the operator safety water supply if the access sensor indicates that the housing has been accessed.

27. The water treatment system of any one of claim 24 wherein the booster pump maintains a system water pressure independent of an external supply water pressure.

28. The water treatment system of claim 1, comprising a communication unit in communication with a remote location thereby enabling remote monitoring and control of the system.

29. A method of treating water in a reservoir, the method comprising:
operating a batching unit to prepare a chemical solution from a supply of chemical;
storing the chemical solution in a batching tank;
responsive to a chemical concentration of the water in the reservoir, operating a dosing unit having at least one dosing pump to add a dose of the chemical solution from the batching tank to the reservoir.

30. The method of claim 29, further comprising determining the chemical concentration of the water in the reservoir.

31. The method of claim 29, wherein operating the dosing unit comprises adding a predetermined dosing volume per dose to the reservoir at varying time intervals.

32. The method of claim 29, wherein operating the dosing unit comprises adding a changeable dosing volume per dose to the reservoir.

33. The method of claim 29, wherein operating the dosing unit comprises determining the dose so as to maintain the chemical concentration within a predetermined range.

34. The method of claim 29, further comprising operating a recirculation pump to recirculate the chemical solution in the batching tank.

35. The method of claim 34, further comprising:
monitoring a plurality of level parameters associated with at least one of the supply of chemical and the batching tank; and
selectively interlocking operation of the batching unit, the recirculation pump, and/or the dosing unit in response to the plurality of level parameters.

36. The method of claim 35, wherein monitoring the plurality of level parameters comprises deriving a level parameter associated with the batching tank by measuring the weight of the batching tank.

37. The method of claim 35, wherein selectively interlocking operation of the batching unit, the recirculation pump, and/or the dosing unit is in response to a measured parameter indicative of a bund fluid level exceeding a predetermined value, a local manual shutdown command, and/or a remote manual shutdown command.
